(19) United States
(12) Patent Application Publication
(10) Pub. No.: US 2014/0049080 A1
(43) Pub. Date: Feb. 20, 2014

(54) Seat hugger/sport hugger

(71) Applicant: Daniel Keith Corbett, Brantford (CA)

(72) Inventor: Daniel Keith Corbett, Brantford (CA)

(21) Appl. No.: 13/987,499

(22) Filed: Aug. 1, 2013

Related U.S. Application Data
(60) Provisional application No. 61/742,169, filed on Aug. 6, 2012.
(60) Provisional application No. 61/742,171, filed on Aug. 6, 2012.
(60) Provisional application No. 61/742,170, filed on Aug. 6, 2012.

(51) Int. Cl. A61G 5/10

(52) U.S. Cl. CPC A61G 5/1043
USPC 297/219.1

(57) ABSTRACT

Sport Hugger or Seat Hugger product is made of nonslip material and designed to help keep the elderly and/or those with physical disabilities and those involved in sports from slipping, sliding and slouching into uncomfortable back positions while in there wheelchairs. Sport Hugger or Seat Hugger nonslip material can be placed between any existing seat cushion or chair pad on the wheelchair or the user can sit directly on the nonslip material for a more secure maximum grip support.

### CROSS-REFERENCE TO RELATED APPLICATION

This application claims the benefit of U.S. patent application No. 13/987,498 filed Aug. 1, 2013, U.S. Provisional Application No. 61/742,169 filed Aug. 6, 2012, U.S. Provisional Application No. 61/742,171 filed Aug. 6, 2012, and U.S. Provisional Application No. 61/742,170, filed Aug. 6, 2012, all of which are incorporated herein by reference.

### BRIEF DESCRIPTION OF THE DRAWINGS

FIG. 1 illustrates the size, shape and dimensions of a Sport Hugger or Seat Hugger;

FIGS. 2A and 2B illustrate screen prints applied to a Seat Hugger and a Sport Hugger;

FIG. 3 illustrates a Sport Hugger or Seat hugger with screen print logo applied; and

FIGS. 4A and 4B illustrate a Sport Hugger or Seat Hugger being used with a standard wheelchair and a sport wheelchair.

### DETAILED DESCRIPTION

Sport Hugger or Seat Hugger for wheelchairs is a flat grey 3943/1460 nonslip material with grip that is provided in bun form then sliced into sheets of 42″×52″ at 3/32 in thickness the nonslip material is then die cut into a custom shape and then screen printed for identification.

Sport Hugger or Seat Hugger nonslip material size is thirteen inches in width and eleven inches in length and three thirty seconds of an inch in thickness. The seat hugger or sport hugger non slip material is also versatile and mobile for the consumer and user's convenience.

Sport Hugger or Seat Hugger nonslip material was designed to help keep the elderly and disability and those involved in sports from slipping, sliding and slouching into uncomfortable back positions while in there wheelchairs. That is caused by upper body weight and slippery surfaces.

Sport Hugger or Seat Hugger nonslip material can be placed between any existing seat cushion or chair pad on the wheelchair or the user can sit directly on the nonslip material for a more secure maximum grip support.

Sport Hugger or Seat Hugger nonslip material will help grip the user to the wheelchair allowing the user to shift their body weight left, right, forward and backwards this will improve moving ability when jolting and shifting their body weight on the Seat Hugger or Sport Hugger nonslip material in place.

Sport Hugger or Seat Hugger nonslip material will grip the user to the wheelchair and help prevent those that lack the strength to keep themselves from slipping and sliding out of the wheelchairs.

Sport Hugger or Seat Hugger nonslip material will give the user a more secure feeling in an upright position and help reduce the chance of future back problems from improper posture seating.

Sport Hugger or Seat Hugger nonslip material is used for wheelchair sports when providing the user with a more secure grip feeling at a faster pace in movement during sports activities.

Sport Hugger or Seat Hugger nonslip material will help keep the user up in an upright position and reduce the over tightness of restraint systems used that causes indentation marks on the stomach area.

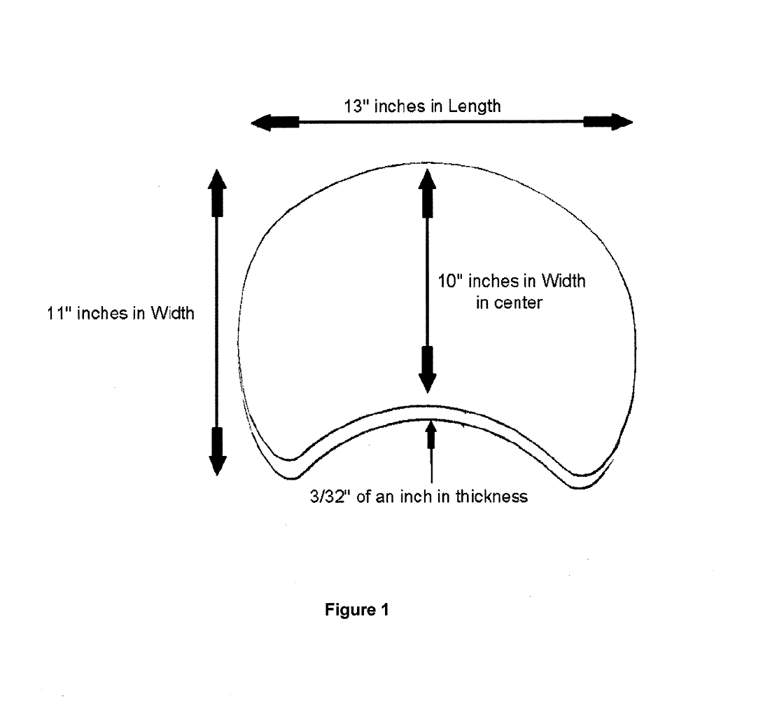

FIG. 1 illustrates the size, shape and dimensions of a Sport Hugger or Seat Hugger. The Sport Hugger or Seat Hugger may be 11 inches in width, and 10 inches in width in the center. The Sport Hugger or Seat Hugger may be 13 inches in length with a thickness of 3.332 of an inch.

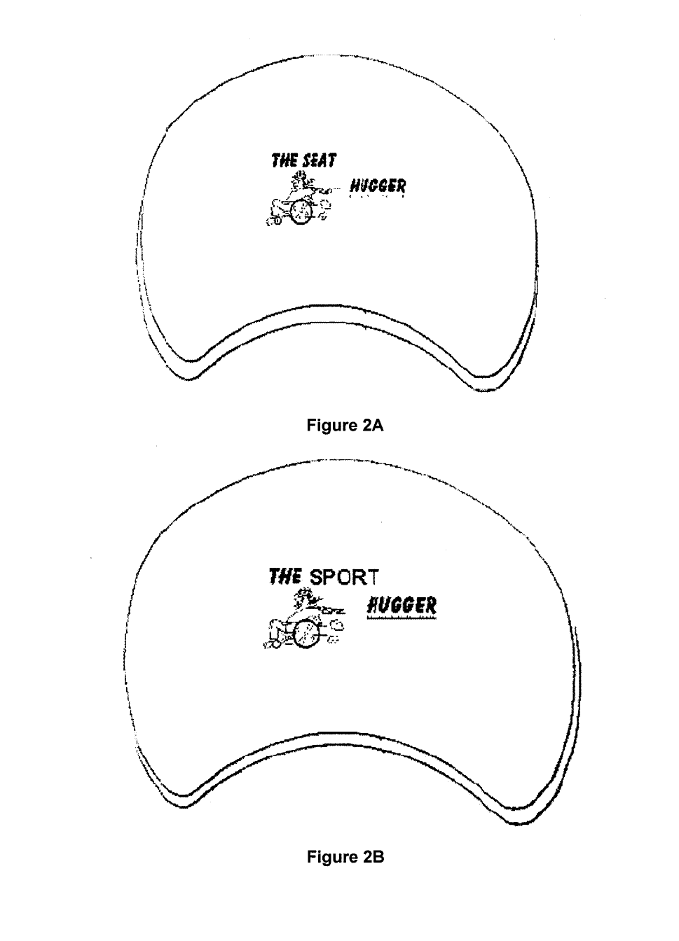

FIG. 2A illustrates a screen print applied to a Seat Hugger while FIG. 2B illustrates a screen print applied to a Sport Hugger.

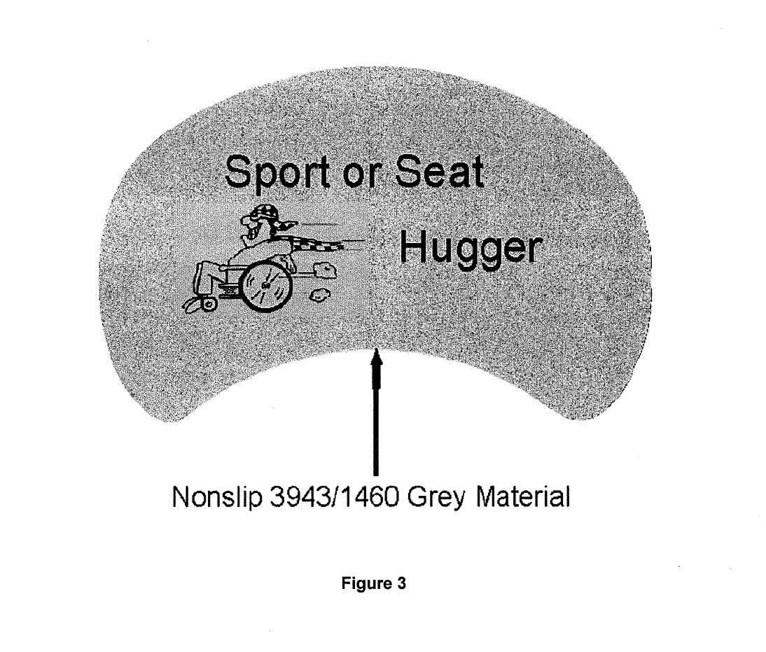

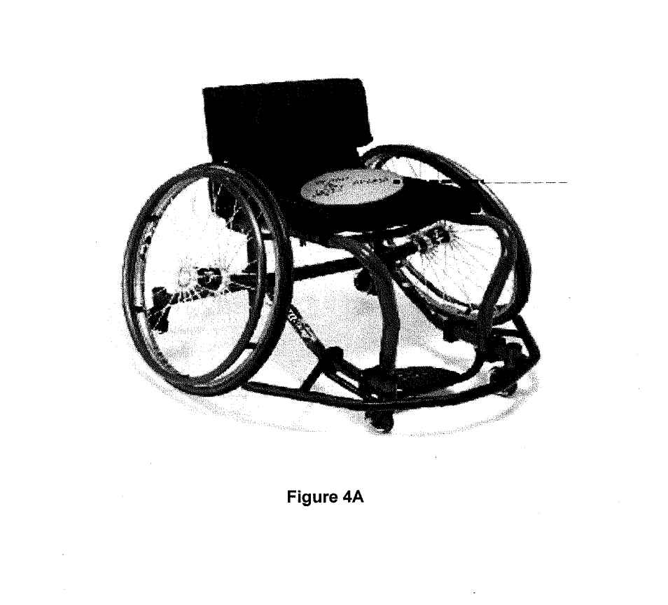

FIG. 3 illustrates a Sport Hugger or a Seat Hugger product with screen printing applied to nonslip 3943/1460 grey material.

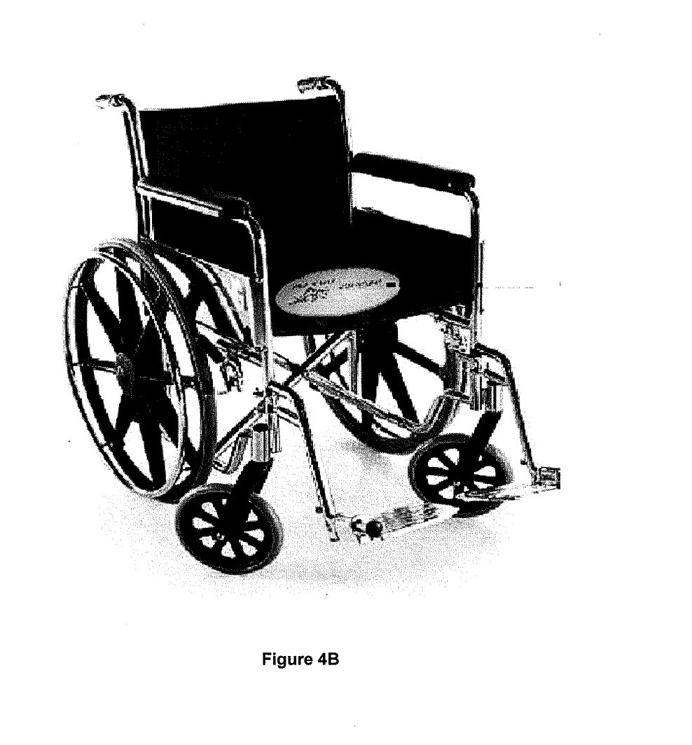

FIG. 4A illustrates a standard wheelchair with a Sport Hugger or Seat Hugger of nonslip 3943/1460 Grey material placed in position on the seating area of the wheelchair. FIG. 4B illustrates a Sport Hugger or Seat Hugger of nonslip 3943/1460 grey material placed in position on the seating area of a sport wheelchair.

What is claimed is:

1. The Sport Hugger or Seat Hugger will help prevent those that lack the strength or ability from slipping or sliding out of wheelchairs or down into uncomfortable back position.

2. The Sport Hugger or Seat Hugger will help to prevent slipping and sliding and slouching to reduce the indentation marks on the stomach area caused by over tightened restraint systems.

3. The Sport Hugger or Seat Hugger will grip the user to the wheelchair and the user can then jolt or shift his or her weight either left, right, forward, or backwards for better directional moving ability.
